(19) United States
(12) Patent Application Publication
(10) Pub. No.: US 2012/0219369 A1
(43) Pub. Date: Aug. 30, 2012

(54) REAMER, CUTTER PLATES THEREFOR AND METHOD FOR ADJUSTING THE MACHINING DIAMETER OF A REAMER OF THIS TYPE

(75) Inventor: Dieter Kress, Aalen (DE)

(73) Assignee: MAPAL FABRIK FÜR PRÄZISIONS-WERKZEUGE DR. KRESS KG, Aalen (DE)

(21) Appl. No.: 13/139,865

(22) PCT Filed: Dec. 15, 2009
(86) PCT No.: PCT/EP09/08960

§ 371 Date: Jun. 15, 2011

(30) Foreign Application Priority Data
Dec. 19, 2008 (DE) 10 2008 064 543.5

(51) Int. Cl. B23D 77/04; B23B 27/16; B23C 5/24

(52) U.S. Cl. 407/45; 407/113; 29/428

(57) ABSTRACT

A reamer includes a base body having at least one insert seat countersunk therein and having at least first and second lateral surfaces. A cutting insert has at least one minor cutting edge inserted in this seat. In addition, a clamping device includes a clamping jaw and an adjustment device for the cutting insert. A first lateral surface is inclined relative to an imaginary vertical line such that the cutting insert is alignable by contacting the lateral surface such that the insert's minor cutting edge has a defined taper, that an opening is provided at the base of the insert seat, through which opening the adjustment part protrudes into the insert seat, and that the cutting insert on its side facing the adjustment part adjoins this part.

The invention relates to a reamer as set forth in the preamble of Claim 1, a cutting insert as set forth in the preamble of Claim 11, a cutting insert as set forth in the preamble of Claim 16, as well as a method for adjusting the machining diameter of a reamer, as set forth in Claim 26.

DE 10 2004 022 941 A1 discloses a reamer and cutting inserts of the type referenced here. The reamer, the function of which is the fine machining of through-holes or blind holes, has a base body that is provided around its outer circumferential surface with a recess in the form of a groove, the recess being open at the edge towards the end face of the reamer. The function of this recess is to receive a cutting insert having multiple geometrically defined cutting edges. At its end opposite the reamer end face, the groove has a first lateral surface and another, second lateral surface that runs towards the longitudinal central axis of the reamer. A clamping device is provided to secure the cutting insert inserted in the groove. The reamer furthermore includes an adjustment device comprising an adjustment part that can be brought into contact with the cutting insert, by which adjustment part the radially projection of the cutting insert is adjusted along the circumferential surface of the base body or—if provision is made for this purpose—along guide strips, and thus the machining diameter of the reamer is adjusted thereby.

The known cutting insert has a main cutting edge that is inclined relative to the feed direction of the reamer and a minor cutting edge that is sloped in the opposite direction. The taper of the minor cutting edge that is adjustable by means of the adjustment device for the cutting insert inserted in the groove is typically in the range of one micrometer (μm) per millimeter (mm), corresponding to an angular deviation of the minor cutting edge relative to the tool axis of 0.057°.

In the known reamer, the cutting insert rests at its end section a distance removed from the reamer end face directly on the groove base, which functions as a counter-bearing, and on the adjustment part at its end facing the reamer end face. The cutting insert is pressed both onto the base and onto the second lateral surface of the groove by the clamping device, and thereby secured in place. When the machining diameter of the reamer is adjusted by adjusting the adjustment part, the cutting insert is pivoted about the peripheral edge contacting the groove base, thereby necessarily resulting in a modification of the taper, which is not always desirable. A value for the taper that is optimal for the specific requirements is thus not always able to be achieved.

The object of this invention is therefore to create a reamer of the type referenced above for which it is possible to easily implement a taper that is definable independently of the given adjusted machining diameter. The object of this invention is also to provide at least one cutting insert suitable for use in the reamer. Another object of the invention is to provide a simplified method for adjusting the machining diameter of the reamer while simultaneously ensuring a defined taper.

To achieve this object, a reamer is proposed that comprises the features of Claim 1. The reamer comprises a base body that is provided with at least one insert seat, where the insert seat has first and second lateral surfaces. In addition, at least one cutting insert having a minor cutting edge is inserted in the insert seat. In order to attach the cutting insert securely and precisely, a clamping device having a clamping jaw is provided, while in order to precisely and preferably easily adjust the machining diameter of the reamer a adjustment device having an adjustment part is provided. The reamer is distinguished by the fact that the first lateral surface of the insert seat is inclined relative to an imaginary vertical line such that the cutting insert is able to be oriented by contacting the lateral surface so that its minor cutting edge has a defined taper, that an opening is provided at the base of the insert seat through which the adjustment part protrudes into the insert seat, and that on its side facing the adjustment part the cutting insert—preferably exclusively—adjoins this part. This design ensures that when the cutting insert is inserted into the insert seat an automatic alignment of the cutting insert is effected by the correspondingly inclined first lateral surface by contacting the cutting insert on this surface, this occurring in such a way that the adjustable, at least one cutting edge has a precise, essentially non-modifiable taper.

The first lateral surface running obliquely or opposite the reamer end face functions preferably as a guide during the adjustment of the cutting insert, that is, during the adjustment of the machining diameter, in particular, as a positive guidance for the cutting insert resting thereon that is displaceable from below by the adjustment part, which also functions as a support for the cutting insert. During the cutting insert's radial displacement for the purpose of adjusting the cutting edge projection over the periphery of the reamer, or along any guide strips that may be provided, the cutting insert is thus not tilted transversely to the longitudinal central axis of the reamer, as is true with the known reamer, which occurrence would first of all produce a change in the taper. Instead, the cutting insert is guided along the first lateral surface of the insert seat—preferably exclusively—translationally while maintaining the precise taper of the minor cutting edge as defined by the arrangement and design of the first lateral surface, and at the same time is displaced relative to the base body of the reamer. The amount of this linear motion is adjustable by means of the adjustment device, while the course of the first lateral surface as well as the accommodation of the cutting insert in the area of the seating contact surface on the first lateral surface are the direction-setting factors.

What is important is that the cutting insert rest by one side on the first lateral surface of the insert seat such that the cutting insert slides along this first lateral surface of the insert seat when the cutting insert is adjusted by the adjustment device. The first lateral surface of the insert seat thus functions here as a guide surface by which the cutting insert resting thereon is positively guided during a radial adjustment to set the protruding section. This ensures that the cutting insert is not tilted, as occurs with the known reamer, but instead the taper angle remains constant. The cutting insert thus always has the same taper regardless of the insert's given radial position, that is, of its protruding section beyond the circumferential surface or beyond the at least one guide strip of the reamer.

The taper that has proven especially advantageous is one micrometer (μm) per millimeter (mm). It should be noted, however, that other tapers/angular deviations for the minor cutting edge relative to the tool axis can also be selected so as to precisely modify the surface properties of the wall of the drilled hole to be machined by the reamer.

In the context of this invention, what is understood by the term “taper” in connection with the reamer is the reduction in diameter of the reamer in the region of its end having the cutting insert opposite the feed direction of the reamer.

Regardless of what value is selected for the taper, it is very important that the specified value selected for the given requirements—for example, high surface quality and/or long tool service lives—is maintained consistently and reliably, and is not altered either by adjusting the diameter or by using the reamer. This requires a reliable and stable clamping of cutting insert, clamping device, adjustment device, and reamer base body.

In one embodiment of the reamer, it has been found advantageous for the first lateral surface of the insert seat to form a stop for the cutting insert, where the first lateral surface is provided on the end of the insert seat that is opposite the end face of the reamer. Among other aspects, the cutting insert is able to be pressed by the clamping jaw against the first lateral surface of the insert seat, where the specified inclination of the first lateral surface, preferably opposite the reamer end face, in combination with the alignment of a clamping groove in the cutting insert ensures that the clamping jaw essentially pulls the cutting insert into the insert seat. This contributes substantially to providing the desired absolutely reliable clamping of the interacting parts of the reamer in the region of the cutting insert.

An embodiment of the reamer is especially preferred in which the adjustment device and the clamping device are disposed at approximately the same distance from the end face of the groove. This enables an extremely compact constructive design to be achieved that is advantageous for the total system. A space-saving arrangement can be achieved, for example, by an approach wherein the clamping device and the adjustment device are distributed around the circumferential surface of the reamer, in particular, are located at least essentially, or for the most part, on opposite sides of a plane spanning the longitudinal central axis of the reamer.

In order to achieve optimum retention of the cutting insert in the insert seat whereby a gripping or clamping force is applied by the clamping device to the cutting insert, the clamping device comprises a clamping jaw with a contactable and/or engageable clamping lip, where the shape of the clamping lip is matched to the clamping surface provided on the cutting insert. The arrangement and design of the cutting insert and of the individual components of the clamping device are matched to each other so that the clamping jaw impinges upon the cutting insert with a gripping/clamping force that is oriented such that a first partial component of this force acts opposite to the feed direction of the reamer towards the stop formed by the first lateral surface, a second force component acts towards the adjustment part, while a third force component acts towards the second lateral surface of the insert seat.

In order to prevent any damage to the cutting insert in response to high gripping/clamping forces, the size and shape as well as arrangement of the clamping lip relative to the cutting insert are matched to the at least one clamping surface provided thereon in such a way that the seating contact surface between these two components is as large as possible, with the result that the effective surface pressure there is correspondingly small.

Additional advantageous embodiments of the reamer are revealed in the subordinate claims.

To achieve the object of the invention, at least one cutting insert including at least one geometrically defined cutting edge is proposed, this cutting insert comprising the features of Claim 11. This has an angular base shape with a rectangular front side that is dividable by an imaginary center line into two halves. In addition, a first clamping groove having at least one clamping surface is provided that is inclined by a preferably acute angle relative to the center line of the first clamping groove. The cutting insert is distinguished by a second clamping groove having at least one clamping surface, the center axis of this groove running orthogonally relative to the center axis of the first clamping groove.

Advantageous embodiments of this cutting insert are revealed in subordinate claims following Claim 11.

To achieve the object of the invention a cutting insert is furthermore proposed comprising the features of Claim 16, the cutting insert having at least one depression with a clamping surface provided therein and being distinguished by the fact that a dome-like protruding clamping body having a clamping surface is disposed or provided at the base of the depression. Based on this design, the point of action of the clamping jaw can be located closer to the active cutting edge, which is preferably disposed at the corner of the cutting insert, while also appropriately locating the depression and the raised clamping body, in particular, given a central positioning on the angular cutting insert, with the result that even extremely small vibrations of the cutting insert can be even more effectively prevented during the cutting process than with, for example, a conventional cutting insert. The essentially vibration-free clamping of the cutting insert provides advantages in terms of tool life, especially when PCBN (polycrystalline cubic boron nitride) is used as the cutting material.

Especially advantageous embodiments of this cutting insert are revealed in the subordinate claims following Claim 16.

Finally, in order to achieve the object of the invention, an adjustment method as set forth in Claim 26 is also proposed for a reamer according to one of Claims 1 through 10.

The following discussion describes the invention in more detail based on the drawing. In the drawing:

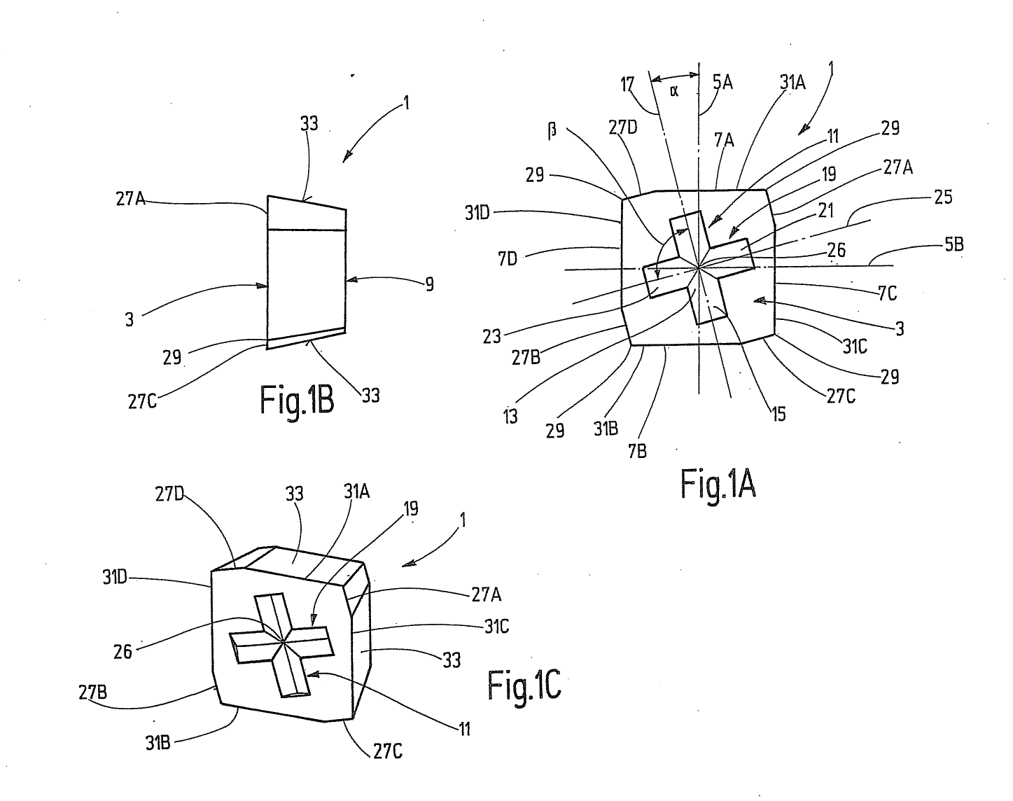

FIG. 1A is a top view illustrating a first embodiment of a cutting insert;

FIG. 1B is a side view of the cutting insert of FIG. 1A;

FIG. 1C is a perspective view of the cutting insert of FIG. 1A;

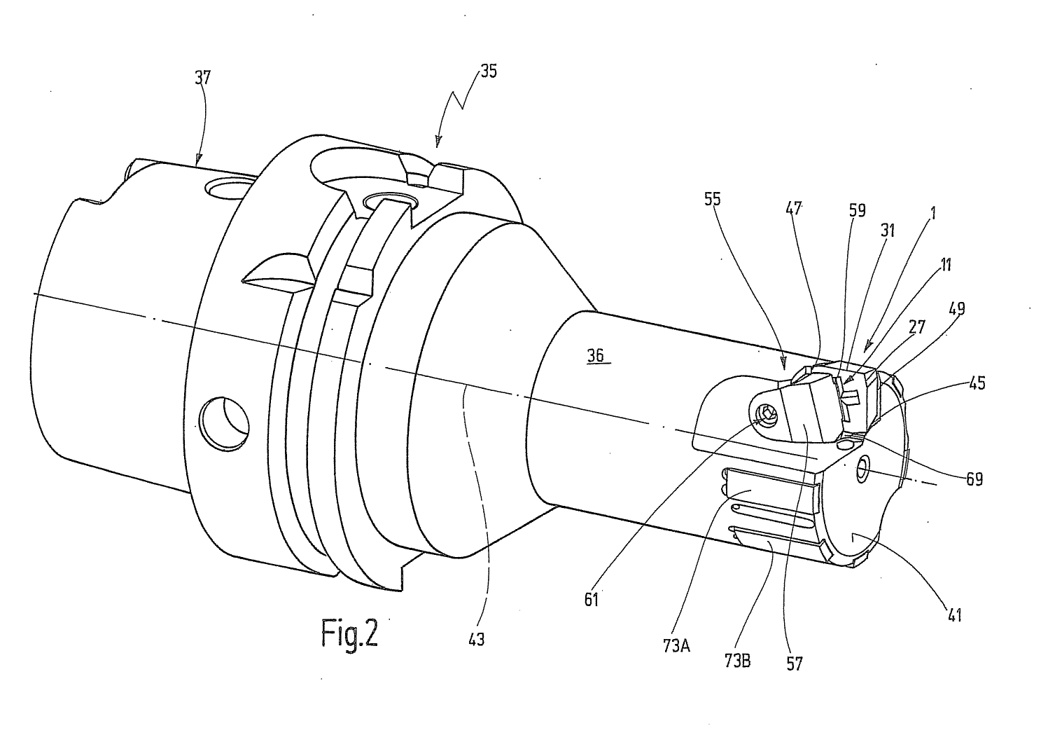

FIG. 2 is a perspective view of an embodiment of a reamer including a cutting insert based on FIGS. 1A through 1C;

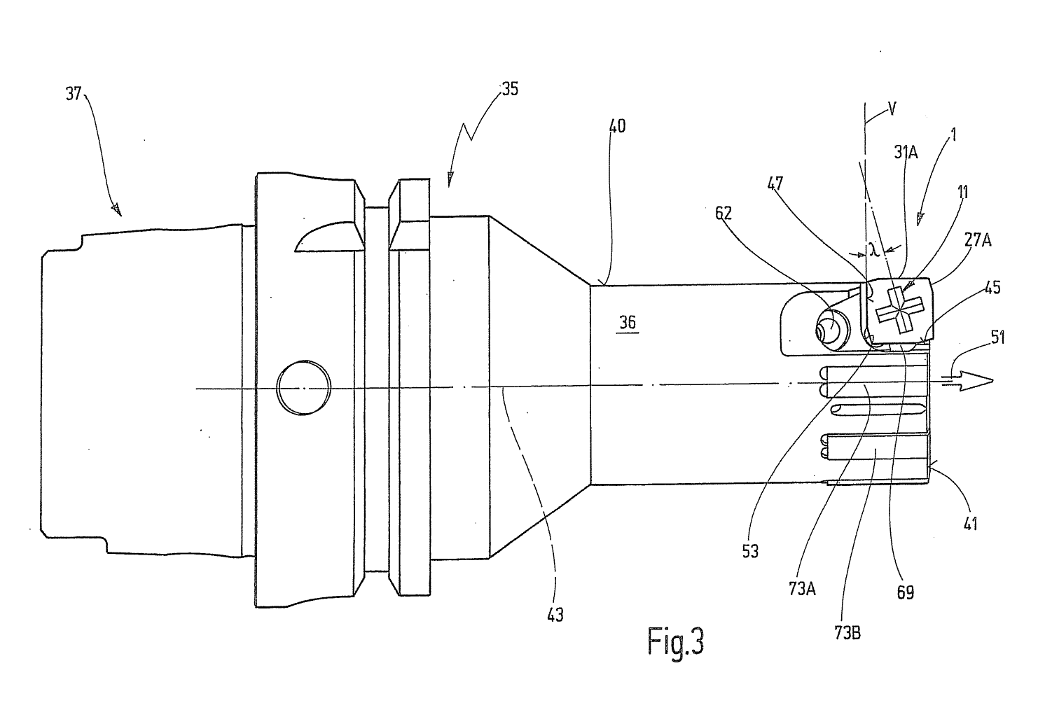

FIG. 3 is a side view of the reamer of FIG. 2;

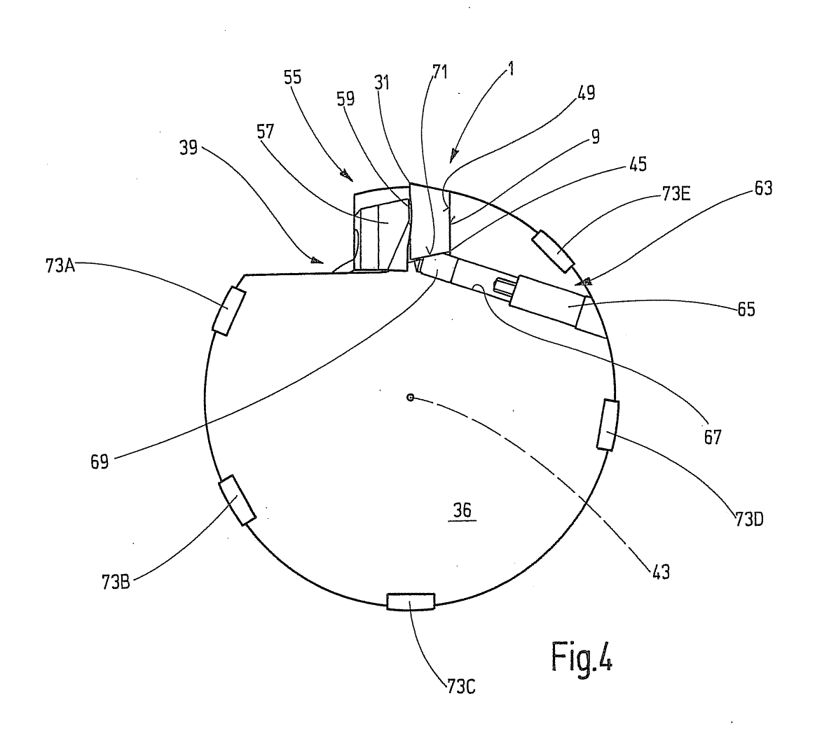

FIG. 4 is a cross-sectional view of the reamer based on FIGS. 2 and 3 in the region of the adjustment device;

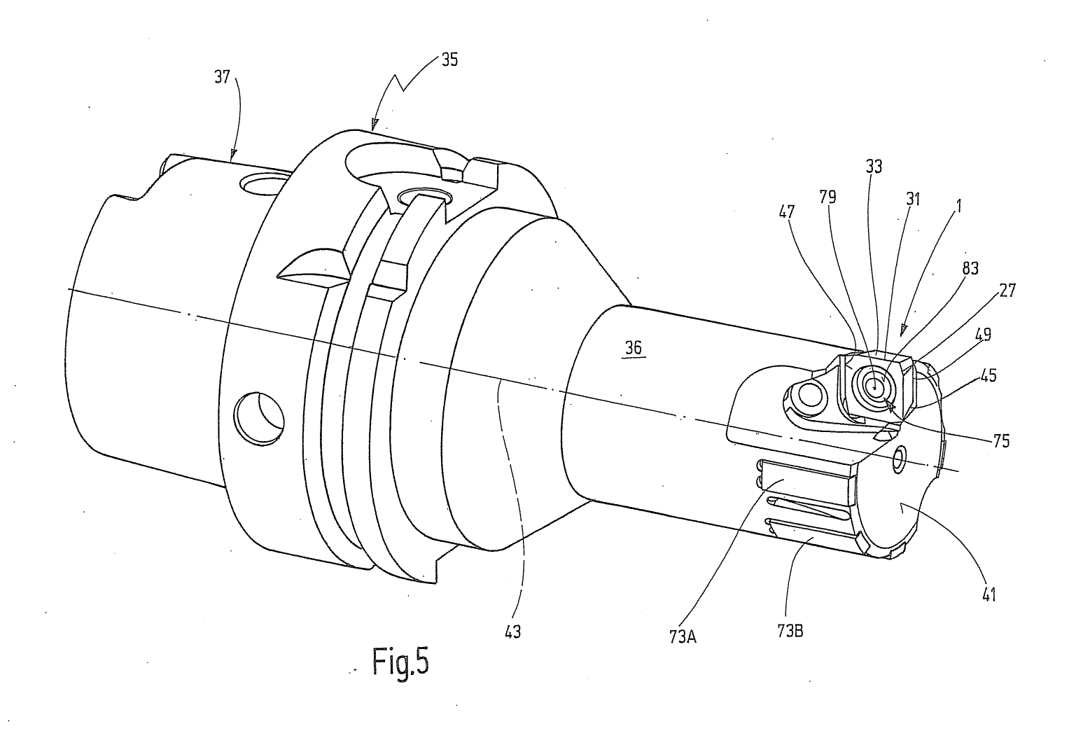

FIG. 5 shows the reamer based on FIGS. 2 through 4 with cutting insert based on a second embodiment;

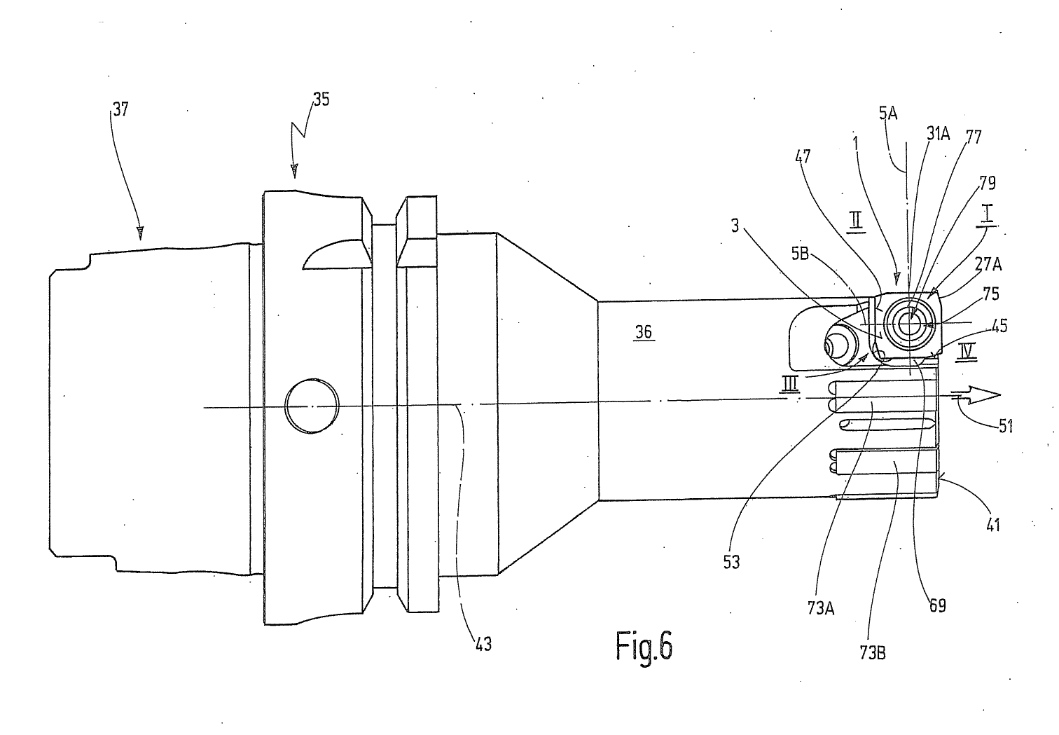

FIG. 6 is a side view of the reamer of FIG. 5;

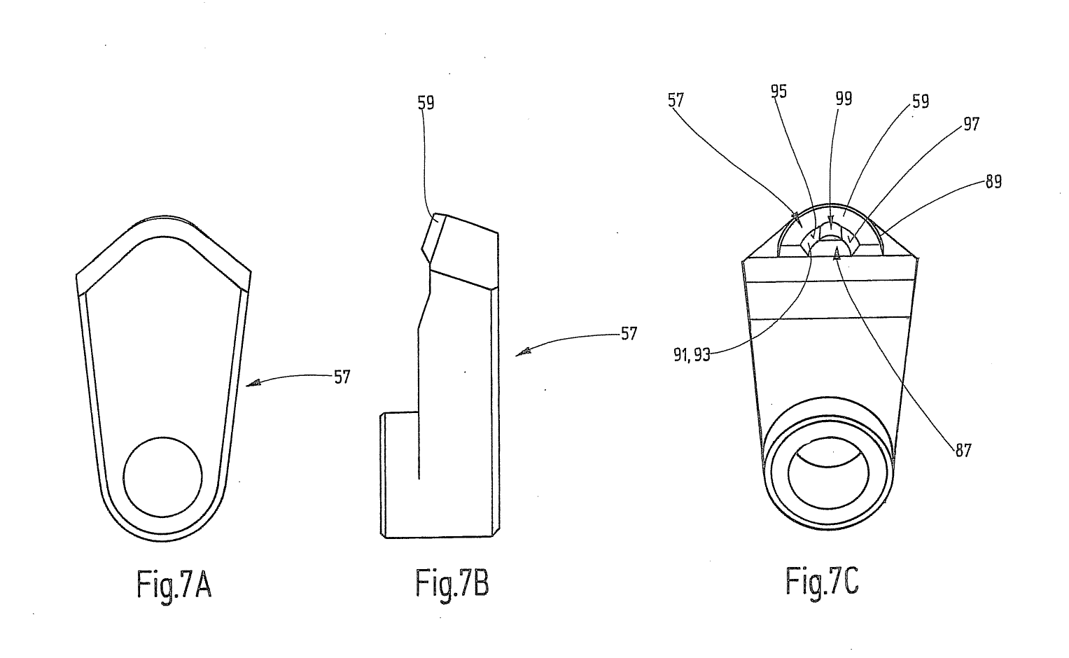

FIG. 7A is a top view illustrating an embodiment of a clamping jaw for the cutting insert of FIG. 5;

FIG. 7B is a side view of the clamping jaw in FIG. 7A;

FIG. 7C is a perspective view illustrating the clamping jaw of FIGS. 7A and 7B as viewed obliquely from below;

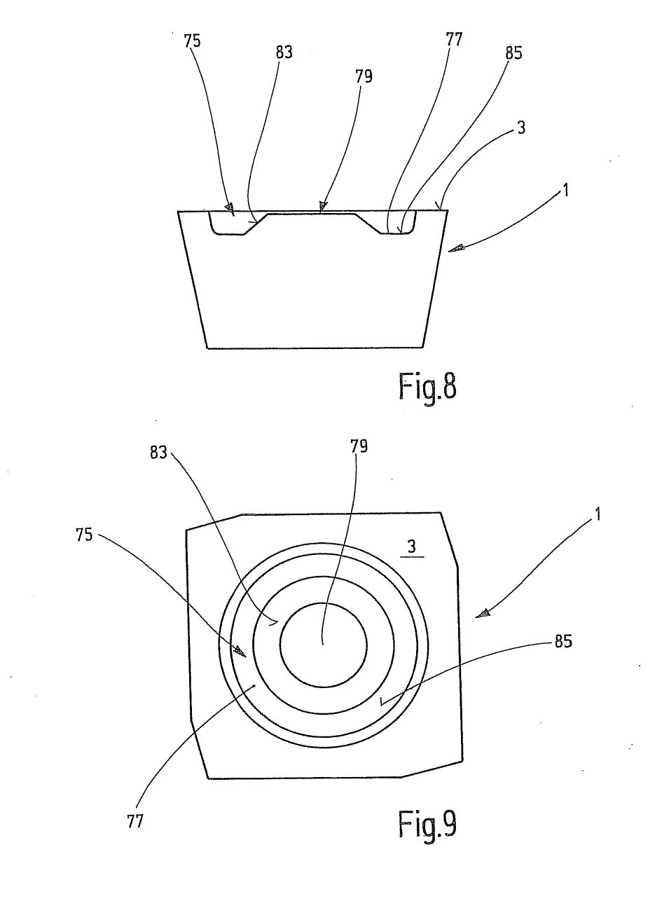

FIG. 8 shows a section of the cutting insert based on the second embodiment as viewed in cross-section; and

FIG. 9 is a top view illustrating the cutting insert of FIG. 8.

FIG. 1A illustrates in very schematic form one embodiment of a disk-like cutting insert 1 that, when the front side 3 is viewed from the top, has a square base shape which is essentially symmetrical and includes mutually orthogonally running center lines 5A and 5B. A first face and second face, respectively, run along mutually parallel first and second peripheral edges 7A and 7B, respectively. Third and fourth faces furthermore run respectively along the two remaining third and fourth peripheral edges 7C and 7D. The faces, which are not specifically identified in the figures, are preferably bounded by a chip groove, not shown, where starting from the associated peripheral edges the faces slope away towards the rear side 9 of cutting insert 1, while the chip grooves rise towards front side 3. Faces and chip grooves of this type are well known and will thus not be described in more detail here.

A first elongated clamping groove 11 is provided at the center of front side 3 between the faces, along with, in this example, a total of two V-shape-oriented clamping surfaces 13 and 15. First clamping groove 11 is symmetrical relative to its center axis 17 that forms an angle α with the center line 5A of cutting insert 1, which angle preferably ranges between 10° and 20°, and in the embodiment illustrated is approximately 15°. In addition, a second clamping groove 19 is provided, also with two V-shape-oriented clamping surfaces 21 and 23, the center axis 25 of which runs orthogonally, that is, perpendicular to center axis 17 of first clamping groove 11. First and second clamping grooves 11 and 19, which are identical in size and shape, intersect each other to form a cross shape.

FIG. 1A clearly reveals that the clamping cross formed by orthogonally running clamping grooves 11 and 19 does not follow the outer contour of the cutting insert, that is, the central axes of clamping groove 11, 19 do not run parallel to the lateral surfaces or peripheral edges 7A and 7B, or 7C and 7D. Clamping grooves 11, 19, which form a quasi-rectangular cross, are pivoted relative to the outer/peripheral edges of the cutting insert by an angle that matches the angle α due to the parallelism between peripheral edges 7A and 7B and cutting insert center line 5B, and between peripheral edges 7C and 7D and cutting insert center line 5A. The angle, about which the clamping cross is pivoted relative to the outer longitudinal edges of the cutting insert by an axis running through intersection point 26 of center lines 5A, 5B, and central axes 17, 25, preferably ranges between 10° and 20°. This produces advantages in terms of breaking up the clamping forces over multiple force components, where one of these ensures the desired high applied force of the cutting insert in the cutting insert seat of the reamer, this being explained in more detail below.

Central axes 17, 25 of clamping grooves 11, 19 thus form an angle β of 90°. The size and arrangement of first and second clamping grooves 11, 19 is furthermore selected such that the faces are not interrupted, that is, the clamping grooves form a circumferentially closed depression on front side 3, where the center point of central axes 17, 25 of first and second clamping grooves 11, 19 coincides with the center point of center lines 5A, 5B of cutting insert 1, and where first and second intersecting clamping grooves 11, 19 are point-symmetrical relative to the center point of center lines 5A, 5B. Clamping grooves 11, 19 are disposed thus point-symmetrically relative to intersection point 26 of center lines 5A, 5B, and central axes 17, 25. Finally, clamping surfaces 13, 15, 21, 23 slope away relative to here flat front side 3 towards the rear side of the cutting insert by an angle that ranges between 10° and 15°. In other words, clamping surfaces 13, 15, 21, 23 run obliquely into the projection plane of FIG. 1A.

Each of the corners of cutting insert 1 are provided with a chamfer; that is, none of peripheral edges 7A through 7D extend completely into the geometric corner of the square base body, but instead slope away in advance of this at an angle relative to center line 5A or 5B. This region, which starts in each case from one of the peripheral edges and slopes away towards the bordering peripheral edge—as seen clockwise in FIG. 1A—forms the geometrically defined main cutting edge 27A, 27B, 27C, or 27D of cutting insert 1 that passes through a vertex 29 into a geometrically defined minor cutting edge 31A, 31B, 31C, or 31D, which is formed by the region of respective peripheral edge 7, this region adjoining vertex 29.

When cutting insert 1 is used, the insert is inserted into a tool such that the given active minor cutting edge 31 slopes away towards the rotational axis of the tool, specifically and typically by approximately 1 micrometer (μm) for one millimeter (mm).

As FIG. 1A reveals, a total of four cutting edge regions are provided for cutting insert 1, which is point-symmetrical relative to intersection point 26, two each of these regions being disposed at diagonally opposite corners of cutting insert 1. A cutting insert having at least two opposing cutting edge regions is known in principle. A cutting insert 1 of this type is also identified as an indexable insert. Whenever main cutting edges 27A through 27D, and each of the associated minor cutting edges 31A, 31B, 31C, and 31D, are worn out, cutting insert 1 can be rotated 90° about an imaginary axis running perpendicular to front side 3 through intersection point 26, thereby making available the main and minor cutting edges following in the direction of rotation for machining a workpiece.

The end faces of the base body are typically disposed at an angle of 90° to front side 3; they thus fall vertically into the projection plane of FIG. 1A in the illustration of FIG. 1A. In the embodiment shown in FIGS. 1A through 1C, however, lateral surfaces 33 of cutting insert 1 bordering peripheral edges 7 are inclined at an angle of <90°; they thus slope towards center line 5A or 5B. If cutting insert 1 is thus viewed from a perspective onto one of the end faces in the illustration of FIG. 1B, then it is essentially trapezoidal, where front side 3 visible in FIG. 1A is wider transversely relative to the center line than is rear side 9 of cutting insert 1 that is opposite front side 3 and runs parallel to this side. The angle by which lateral surfaces 33 slope away as viewed from peripheral edges 7 is identified as the clearance angle, which preferably is approximately 11°.

In the embodiment of cutting insert 1 described based on FIGS. 1A through 1C, main cutting edges 27 can be can be machined out of the base body of cutting insert 1. Another conceivable approach, however, is to insert an insert composed, for example, of PCBN into the base body in the region of main cutting edges 27 and minor cutting edges 31. In this case, the faces, and any chip grooves provided, would only extend across the length of this insert.

FIG. 2 is a perspective view illustrating an embodiment of a fine boring tool, which here is composed of a reamer 35 including a base body 36. A hollow taper shank 37 adjoins base body 36 to couple reamer 36 into or onto a machine tool.

An insert seat 39, composed here of an edge-open groove, is provided on the front end of base body 36 of reamer 35 to receive above-described cutting insert 1. Insert seat 39 is open towards the end face 41 of reamer 35 and towards the circumferential surface 40 of base body 36, and runs essentially parallel to the rotational axis 43 of reamer 35. Due to its end-side location on base body 36, insert seat 39 has only three walls, specifically a base 45, and first and second lateral surfaces 47 and 49, each of which is flat. First lateral surface 47 is provided on the end of insert seat 39 opposite end face 41 of reamer 35, and also forms an axial stop for cutting insert 1. Here first lateral surface 47 is inclined opposite the feed direction identified in FIG. 3 by a double arrow 51; it thus slopes away from end face 41 of reamer 35. It becomes clear that first lateral surface 47 runs transversely relative to the feed direction of the reamer, as is also evident in FIGS. 2 and 3. In the embodiment shown in FIGS. 2 and 4, second lateral surface 49 is oriented perpendicular or at least essentially perpendicular to first lateral surface 47, and runs parallel to the longitudinal central axis of the reamer, which coincides here with rotational axis 43.

As is especially evident in FIG. 2, insert seat base 45 extends from end face 41 up to the end-side stop formed by first lateral surface 47, where base 45 lies in a plane, above rotational axis 43, that is at least essentially parallel to a feed direction. In the embodiment shown in FIGS. 2 through 4, base 45, as well as first and second lateral surfaces 47, 49, are flat. An exposure 53 is provided in the transitional region between first lateral surface 47 and base 45 in order to ensure a precisely defined position for cutting insert 1, and to prevent any damage to cutting insert 1 inserted in the insert seat in the cutting region located in this transitional region. An exposure of this type can also be provided in the transitional region between base 45 and second lateral surface 49.

Reamer 35 furthermore comprises a clamping device 55 visible in FIGS. 2 and 4 to secure in place cutting insert 1 in insert seat 39. Clamping device 55 comprises a clamping jaw 57 that by a clamping lip 59 engages first clamping groove 11 on front side 3 of cutting insert 1. Clamping device 55 has a clamping screw 61 that preferably has two threaded sections that feature opposite pitches. A first threaded section engages an internal thread that is provided in a through-hole, which extends through clamping jaw 57 and functions to receive clamping screw 61. The second threaded section of clamping screw 61 engages base body 36 of reamer 35 in the region of opening 62. What is important is that the cutting insert not be secured by clamping screw 61 directly, that is directly through clamping jaw 57, to the round body of the tool. To this end, the clamping jaw engages the specially oriented grooves on the cutter front.

Reamer 35 furthermore comprises an adjustment device 63 with only one adjustment screw 65, which interacts by its outer thread with the internal thread of a secantially running drilled hole 67 that is incorporated in base body 36 of reamer 35. When adjustment screw 65 is turned, it is screwed a greater or lesser distance into base body 36 of the reamer, where it acts either directly on lateral surface 33 of cutting insert 1 facing insert seat base 39 or, as shown here, through a conical adjustment part 69 that projects through an opening, provided in base 45 of cutting insert 39, into insert seat 39—specifically far enough so as to ensure that cutting insert 1 does not have any contact with insert seat base 45 and rests on or contacts only an oblique surface 71 provided on the end face of adjustment part 69. This surface is sized accordingly, FIG. 3 revealing that adjustment part 69 extends only over part of the length of the insert seat base and is thus relatively small. Since cutting insert 1 does not contact the insert seat base, and the insert seat base does not have either an alignment function or a support function for the cutting insert, the insert seat base does not need to be implemented precisely, or all that precisely, and this factor reduces the cost of the tool.

What is important about the embodiment of the reamer illustrated in the Figures is that due to the projection of the conical adjustment part 69, which is provided at the end of the adjusting screw 65, over base 45 of edge-open groove 39, the actual cutting insert seat is formed by the first and second lateral surfaces and oblique surface 71 on adjustment part 69. When the cutting insert is clamped in place by clamping device 55, the cutting insert is essentially pulled into this insert seat because of the clamping cross that is pivoted relative to the outer edges of the cutting insert, the cross being formed by clamping grooves 11, 19 running orthogonally relative to each other. This achieves a precise seating of the cutting insert against the walls (lateral surfaces 47, 49, and oblique surface 71) of the insert seat with the desired high applied force, with the result that a reliable and reproducible anchoring of the cutting insert can be ensured. The preferably flat seating contact between cutting insert and the walls of the insert seat also remains in place during adjustment of the projection of the cutting insert beyond the circumferential surface of the reamer by the adjustment device, where the cutting insert slides by its lateral surface facing first lateral surface 47 along first insert seat lateral surface 47 without the cutting insert's being tilted in the process. Any change in the taper of the minor cutting edge can thus be reliably prevented despite the change in the radial position of the cutting insert.

FIG. 2 together with FIG. 4 reveal that the clamping device and the adjustment device are disposed at approximately the same distance from end face 36. In this embodiment, this can be attributed to an essentially opposing configuration of the clamping device and the adjustment device, which approach provides an especially compact constructive design. The relatively flat oblique surface 71 on adjustment part 69 enables an extremely sensitive adjustment to be achieved. In addition, very high forces can be applied to the cutting insert and also radially acting chipping forces can be accommodated when adjustment is effected.

When adjustment screw 61 is made to rotate by an appropriate tool, clamping jaw 57 is pulled tight in an initial direction of rotation, with the result that clamping lip 59 interacts with clamping surfaces 13 or 15 of first clamping groove 11. Due to the oblique orientation of first clamping groove 11, which was described based on FIGS. 1A through 1C, the clamping forces applied thereby are split up into at least two force components: A first force component acts perpendicular to center line 5A of cutting insert 1, that is, into the projection plane of FIG. 1, while a second force component acts towards center line 5A, here to the left.

In the illustration of FIGS. 2 and 3, it is assumed that the right front top corner of cutting insert 1 has main cutting edge 27 and minor cutting edge 31, as was explained above in detail based on FIG. 1. In the illustration of FIG. 3, main cutting edge 27 slopes towards feed direction 51. Due to the appropriate arrangement and adjustment of cutting insert 1 in insert seat 39, minor cutting edge 1 accordingly slopes opposite feed direction 51 relative to rotational axis 43 of reamer 35.

FIG. 3 illustrates reamer 35 together with cutting insert 1 inserted into insert seat 39—however, without the clamping device. Clamping groove 11 interacting in this position of cutting insert 1 with clamping jaw 57 is inclined by an angle λ relative to an imaginary vertical line V opposite the feed direction, which angle ranges between 10° and 20°, and in particular is about 15° here. Angle of inclination λ and angle β are essentially the same size here, this being possible, for example, due to the appropriate arrangement of the lateral surfaces of the insert seat and to the base shape of the cutting insert, as well as to the described arrangement of the clamping groove on the front side of the cutting insert. This ensures that cutting insert 1 is reliably pressed onto first and second lateral surfaces 47, 49 of insert seat 39, as well as onto adjustment part 69 of adjustment device 63. In other words, clamping jaw 57 pulls the cutting insert into the insert seat, where a major component of the clamping or gripping forces act on second lateral surface 49 of insert seat 39 due to the clamping jaw and its arrangement on the reamer base body, where clamping forces are also applied to first lateral surface 47 due to the cutting insert's being pulled into insert seat 39. Cutting insert 1 adjoining this lateral surface is also positioned in somewhat twisted fashion relative to the longitudinal central axis of reamer 35 due to the only slight but sufficient inclination of first lateral surface 47 of insert seat 39. What results from this measure is a taper on minor cutting edge 31 that is precisely defined and can be reliably maintained.

When the machining diameter of reamer 35 is adjusted, cutting insert 1 adjoining first and second lateral surfaces 47, 49 of insert seat 39 and adjustment part 69 is pressed radially outward by the adjustment device. In the process, lateral surface 33 of cutting insert 1 adjoining first insert seat lateral surface 47 slides along insert seat lateral surface 47, without the taper of minor cutting edge 31 being changed. What occurs is thus a parallel displacement of the active minor cutting edge, whereby cutting insert 1, while contacting the first lateral surface, is displaced radially outward or moved inward.

When the machining diameter of the reamer is adjusted, clamping jaw 57 is preferably already pretensioned, with the result that cutting insert 1 is retained without play in insert seat 39, and as a result settling movements of this attachment system are prevented. Subsequently, cutting insert 1 is pressed radially outward in response to the adjustment of adjustment part 69, with the result that the clamping force acting on cutting insert 1 is further increased relative to vertical line V due to the angle of the clamping groove flank, that is, of clamping surface 13 and the pivot angle of clamping groove 11. The above-mentioned angular conditions enable a kind of wedge mechanism to be created that contributes to cutting insert 1 being optimally clamped within the base body of reamer 35. The clamping force here—as already described—operates in various directions of action that are matched to each other due to the arrangement of the clamping groove, such that the cutting insert rests securely and reliable on the seating surfaces of the insert seat and on the seating surface of the adjustment means, where these seating surfaces each function as counter-bearings for cutting insert 1.

What is most important in light of the above, is that chipping forces act on the cutting insert when a drilled hole is machined—for example, radial, axial, and tangential forces in the region of the first cut. Depending on material, cutting geometry, and cut values, the ratio of these forces relative to each other, or the value for the individual force components, changes. It has been found, however, that cutting insert 1 is supported in base body 36 or in insert seat 39 of reamer 35 such that these forces are also transferred into and supported in the support surfaces on the cutting insert rear side 9, and into first and second lateral surfaces 47, 49 of the insert seat in reamer base body 36. Due to the described optimal tensioning of the cutting insert during clamping and subsequent adjustment of the same, no settling movements or vibrations are created even in response to the action of the chipping forces, and the set values for the machining diameter and the taper continue to be reliably maintained.

By way of example, five guide strips 73A through 73E are inserted in circumferential surface 40 of reamer 35, these functioning to guide reamer 35 within a drilled hole to be machined.

FIGS. 5 and 6 each provide a view of another embodiment of reamer 35 that differs from the reamer described based on FIGS. 1A through 4 only in terms of the design of cutting insert 1 and of clamping jaw 57. Identical parts are provided with identical reference numerals, and thus reference is made to the description of the previous figures. The following discussion describes only the differences in detail.

In place of the cross grooves, a here conical depression 75 is incorporated in front side 3, also identified as cutter front, which depression does not penetrate through cutting insert 1 but instead is designed as a kind of blind hole.

As is evident in FIGS. 8 and 9 that provide a cross-sectional view through the cutting insert of FIGS. 5 and 6, or a top view of the front side of this cutting insert, base 77 of depression 75 is of smaller diameter than in the region of front side 3 of cutting insert 1. Alternatively, it is possible also to design depression 75 as cylindrical. A dome-like clamping body 79 protruding towards front side 3 is provided at base 77 of depression 75, at least part of the peripheral surface 81 of the body forming clamping surface 83 that interacts with clamping device 55. Clamping body 79, which is of a one-piece integrated design with the cutting insert, tapers down towards its free end region and has an overall base shape of a truncated cone. A flat annular surface 85 is provided on base 77 between clamping body 79, which is disposed concentrically relative to depression 75, essentially rises out of base 77 and the wall of depression 75, thereby creating a free space which an appropriate clamping jaw, such as, for example, that described based on FIGS. 7A through 7C, can engage by its clamping lip.

FIGS. 7A through 7C each provide a view of an embodiment of clamping jaw 57 that is capable of securely clamping in the desired manner cutting insert 1, as illustrated in FIGS. 5, 6, 8, and 9, onto reamer 35. As is especially evident in FIG. 7C, clamping jaw 57 has a clamping lip 59 that is of essentially semicircular design and is provided at it center region with an edge-open recess 87. The outer wall 89 of clamping lip 59 is matched to the wall of depression 75 located in cutting insert 1, and the inner wall 91 is matched to the clamping surface 83 on clamping body 79, such that walls 89 and 91 can be rest flat against the outer surface of the clamping body of the cutting insert, which surface functions as clamping surface 83, when cutting insert 1 is in the tensioned state.

Inner wall 91 of clamping lip 57 thus forms a clamping surface 93 interacting with clamping body 79. This is provided with a gap 99 that subdivides clamping surface 93 into here two identically sized, mutually separate partial clamping surfaces 95 and 97. As a result, two mutually spaced seating surfaces are defined.

In order to secure cutting insert 1 inserted in insert seat 39 of reamer 35, clamping lip 59 of clamping jaw 57 is introduced into annular depression 75, and clamping jaw 57 is clamped by clamping screw 61, not shown in FIGS. 5 and 6. Here partial clamping surfaces 95, 97 of clamping jaw 57 come into contact with clamping surface 83 of the clamping body on cutting insert 1. What is important is that the arrangement of the partial clamping surfaces on clamping jaw 57 be selected such that these seating contact regions are located in the area of the circumferential region of the clamping body close to the active cutting edge of the cutting insert, so that, as with the reamer described based on FIGS. 2 through 4, the applied clamping forces are divided up into force components that press the cutting insert against its seating surfaces on base body 36 of the reamer, these surfaces functioning as a counter-bearing, or on the adjustment part of the adjustment device.

In the embodiment of FIG. 6, the partial clamping surfaces of clamping jaw 57 for the most part adjoin the region of clamping surface 83 of clamping body 79 located to the right of center line 5A, thus in the first quadrant of the coordinate system provided with reference character “I”, the coordinate axes of the system being created by center lines 5A and 5B of cutting insert 1. It is clear that the clamping lip partially adjoins the regions lying in the second quadrant II and fourth quadrant IV in this embodiment of the cutting insert and of the clamping device. What is important is that the clamping forces applied to the clamping body close to active cutting edges 31A and 27A of the cutting insert be transferred into the insert, and be transferred into base body 36 of reamer 35 at the contact surfaces of the cutting insert on insert seat lateral surfaces 47 and 49, and at the contact surface of the adjustment part.

To sum up, what is important is that a very efficient reamer is created by the clamping systems described based on the figures, which reamer is also easy to handle. Adjustment of this tool, in other words, adjustment of the reamer, is possible by simple means and can readily be performed reliably by less experienced personnel without special equipment. The proposed clamping system enables an increased stability and secure clamping of the cutting insert to be consistently ensured.

1-26. (canceled)

27. A cutting insert comprising:
at least one geometrically defined cutting edge;
an angular base shape;
a rectangular front side;
an imaginary center line dividing the front side into two halves;
a first clamping groove having at least one clamping surface, a central axis of the first clamping groove inclined relative to the imaginary center line by an angle; and
a second clamping groove having at least one clamping surface, a central axis of the second clamping groove running orthogonally relative to the central axis of the first clamping groove.

28. The cutting insert according to claim 27, wherein a center point of the central axes of the first and second clamping grooves coincides with a center point of the imaginary center line of the cutting insert, and further wherein the first and second clamping grooves are point-symmetrical relative to the center point of the imaginary center line.

29. The cutting insert according to claim 27, wherein the first and second clamping grooves each have at least one clamping surface.

30. The cutting insert according to claim 27, wherein the first and second clamping grooves each have two clamping surfaces symmetrical relative to the central axis of the respective clamping groove.

31. The cutting insert according to claim 27, wherein the at least one of the clamping surfaces slopes away from the front side by an angle that ranges between 10° and 15°.

32. The cutting insert according to claim 27, wherein the central axis of the first clamping groove is inclined relative to the center line by an angle that ranges between 10° and 20°.

33. The cutting insert according to claim 27, wherein the front side is generally square in shape.

34. The cutting insert according to claim 27, wherein the cutting insert is an indexable insert.

35. The cutting insert of claim 27 in combination with a reamer, the reamer comprising:
a base body;
at least one insert seat countersunk into the base body and including at least first and second lateral surfaces; the cutting insert inserted into the insert seat and including at least one minor cutting edge;
a clamping device that clamps in place the cutting insert in the insert seat and includes a clamping jaw, the cutting insert able to be brought into contact with at least the second lateral surface of the insert seat under the action of the clamping jaw; and
an adjustment device including an adjustment part by which the projection of at least one cutting edge of the cutting insert is adjustable over a circumferential surface or over at least one guide strip of the reamer;
wherein the first lateral surface is inclined relative to an imaginary vertical line such that the cutting insert is alignable by contacting the lateral surface so that its minor cutting edge has a defined taper;
wherein an opening is provided at the base of the insert seat through which opening the adjustment part protrudes into the insert seat; and
wherein the cutting insert at a side facing the adjustment part adjoins the adjustment part.

36. The combination according to claim 35, wherein the cutting insert is displaceable along the first lateral surface of the insert seat by the adjustment part, preferably with the clamping device at least pretensioned.

37. The combination according to claim 35, wherein the first lateral surface forms a stop for the cutting insert, and the first lateral surface is provided on the end of the insert seat opposite the end face of the reamer.

38. The combination according to claim 35, wherein at least the first lateral surface of the insert seat is flat.

39. The combination according to claim 35, wherein the cutting insert rests flat by its seating contact surfaces on at least one of the first lateral surface, the second lateral surface, and the seating contact surface of the adjustment part.

40. The combination according to claim 35, wherein the adjustment device and the clamping device are disposed at approximately the same distance from the end face of the insert seat.

41. The combination according to claim 35, wherein the clamping jaw of the clamping device has a clamping lip, and the shape of the clamping lip matched to the clamping surface provided on the cutting insert.

42. The combination according to claim 41, further comprising a clamping jaw with a clamping lip provided for the cutting insert, the clamping jaw being a straight beam with an essentially flat clamping surface.

43. The combination according to claim 41, further comprising a clamping jaw with a clamping lip provided for the cutting insert, which clamping jaw is at least generally curved.

44. The combination according to claim 43, wherein the clamping lip includes a gap that subdivides the clamping surface into at least two separate partial clamping surfaces.

45. A cutting insert comprising:
at least one geometrically defined cutting edge;
an angular base shape; and
a dome-like protruding clamping body provided at a base of the depression, the clamping body having a clamping surface.

46. The cutting insert according to claim 45, wherein the clamping body tapers down towards a free end region.

47. The cutting insert according to claim 45, wherein the depression tapers down towards its base.

48. The cutting insert according to claim 45, wherein the clamping body has the shape of a cone.

49. The cutting insert according to claim 45, wherein the clamping body has the shape of a truncated cone.

50. The cutting insert according to claim 45, wherein the depression is conical.

51. The cutting insert according to claim 45, wherein the clamping body is oriented concentrically relative to the depression.

52. The cutting insert according to claim 45, wherein an outside diameter of the clamping body at the base of the depression is smaller than an inside diameter of the depression at its base.

53. The cutting insert according to claim 45, wherein the clamping body is of a one-piece integrated design with the cutting insert.

54. The cutting insert according to claim 45, wherein the front side is generally square in shape.

55. The cutting insert according to claim 45, wherein the cutting insert is an indexable insert.

56. The cutting insert of claim 45 in combination with a reamer, the reamer comprising:
a base body;
at least one insert seat countersunk into the base body and including at least first and second lateral surfaces, the cutting insert inserted into the insert seat and including at least one minor cutting edge;
a clamping device that clamps in place the cutting insert in the insert seat and includes a clamping jaw, the cutting insert able to be brought into contact with at least the second lateral surface of the insert seat under the action of the clamping jaw; and
an adjustment device including an adjustment part by which the projection of at least one cutting edge of the cutting insert is adjustable over a circumferential surface or over at least one guide strip of the reamer;
wherein the first lateral surface is inclined relative to an imaginary vertical line such that the cutting insert is alignable by contacting the lateral surface so that its minor cutting edge has a defined taper;
wherein an opening is provided at the base of the insert seat through which opening the adjustment part protrudes into the insert seat; and
wherein the cutting insert at its side facing the adjustment part adjoins the adjustment.

57. A method for adjusting a machining diameter of a reamer according to claim 56, the method comprising:
inserting the cutting insert into the insert seat;
tightening the clamping screw to the extent that the cutting insert contacts the first and second lateral surfaces of the insert seat without play with a defined pretensioning force; and
moving the adjustment part along with essentially radial displacement of the cutting insert along the first lateral surface of the insert seat into the radial position corresponding to the desired diameter of the reamer.
